(19) United States
(12) Patent Application Publication
(10) Pub. No.: US 2019/0031561 A1
(43) Pub. Date: Jan. 31, 2019

(54) COATED GLASS WITH WINDOW AREA AND FABRICATION METHOD THEREOF

(71) Applicant: HUAWEI TECHNOLOGIES CO., LTD., Shenzhen (CN)

(72) Inventors: Geng LIN, Shanghai (CN); Yihong HUANG, Shanghai (CN)

(73) Assignee: HUAWEI TECHNOLOGIES CO., LTD., Shenzhen (CN)

(21) Appl. No.: 16/071,492

(22) PCT Filed: Jan. 20, 2016
(86) PCT No.: PCT/CN2016/071455

§ 371 Date: Jul. 20, 2018

(51) Int. Cl. C03C 17/34; C03C 17/245; C03C 23/00

(52) U.S. Cl. CPC C03C 17/34; C03C 17/245; C03C 23/0075; C03C 2218/328; C03C 2217/72; C03C 2218/15; C03C 2217/228

(57) ABSTRACT

The present disclosure relates to a fabrication method of coated glass with a window area. The method includes: coating a base layer with a cerium oxide CeO2 film layer or a lanthanum oxide La2O3 film layer by using a vapor deposition method, wherein the base layer comprises to-be-coated glass, or to-be-coated glass and another layer coated on the to-be-coated glass; coating an ink layer onto the CeO2 film layer or the La2O3 film layer, wherein the ink layer is coated in a non-window area; and soaking the coated glass that has been coated with the ink layer in a weak acid solution, so as to deplate the CeO2 film layer or the La2O3 film layer in a window area.

### TECHNICAL FIELD

This application relates to the glass processing field, and in particular, to coated glass with a window area and a fabrication method thereof.

### BACKGROUND

In the industry of consumer electronic terminal products, a product appearance is possibly a decisive factor for a consumer to decide whether to buy a product. Therefore, appearance design of an electronic terminal product becomes particularly important. Decorative appearance design of external glass of the electronic terminal product is a common means.

Currently, coating glass and then performing deplating on a window area is a common glass decoration processing technique. Generally, glass is coated with an optical coating material, such as titanium oxide, lanthanum titanate, silicon oxide, chromium metal, or indium tin oxide. The foregoing materials can be rapidly corroded only by a strong acid or a strong alkali. Therefore, the strong acid or the strong alkali is used to perform deplating on a window area.

However, the strong acid or the strong alkali is relatively strongly corrosive to glass, especially for current mainstream new glass, such as Corning gorilla glass 4, and consequently causes a visible scratch on the glass.

### SUMMARY

This application provides coated glass with a window area and a fabrication method thereof, so as to reduce corrosion on glass in a coating process.

To achieve the foregoing objective, this application provides the following technical solution.

A first aspect of this application provides a fabrication method of coated glass with a window area. The method includes the following steps: coating a base layer with a cerium oxide CeO₂ film layer or a lanthanum oxide La₂O₃ film layer by using a vapor deposition method, where the base layer includes to-be-coated glass, or to-be-coated glass and another layer coated on the to-be-coated glass; coating an ink layer onto the CeO₂ film layer or the La₂O₃ film layer, where the ink layer is coated in the non-window area; and soaking the coated glass that has been coated with the ink layer in a weak acid solution, so as to deplate the CeO₂ film layer or the La₂O₃ film layer in the window area.

In the fabrication method, the glass is coated with CeO₂ or La₂O₃, and deplating is performed on the window area by using the weak acid due to a characteristic that CeO₂ or La₂O₃ is easily dissolved in a weak acid. The weak acid is less corrosive than a strong acid or a strong alkali, and therefore, corrosion on the glass can be reduced.

In an implementation of the first aspect, the weak acid solution is a 0.01 mol/L to 5 mol/L acetic acid solution or a 0.01 mol/L to 5 mol/L citric acid solution.

In another implementation of the first aspect, the coated glass that has been coated with the ink layer is soaked in the weak acid solution for five seconds to five minutes.

In another implementation of the first aspect, after the soaking the coated glass that has been coated with the ink layer in a weak acid solution, the method further includes: taking out the soaked coated glass and cleaning the coated glass.

In another implementation of the first aspect, before the coating to-be-coated glass with a CeO₂ film layer or a La₂O₃ film layer by using a vapor deposition method, the method further includes:

attaching a decorative texture to the to-be-coated glass, where the decorative texture is attached to the non-window area; and

the coating a base layer with a CeO₂ film layer or a La₂O₃ film layer by using a vapor deposition method includes:

coating the base layer with the CeO₂ film layer or the La₂O₃ film layer by using the vapor deposition method, where the base layer includes the to-be-coated glass and the decorative texture attached to the to-be-coated glass.

A second aspect of this application provides coated glass with a window area, including glass with the window area and a non-window area, a CeO₂ film layer or a La₂O₃ film layer disposed on the glass, and an ink layer coated onto the CeO₂ film layer or the La₂O₃ film layer, where the CeO₂ film layer or the La₂O₃ film layer is coated in the non-window area other than the window area, and the ink layer is coated in the non-window area other than the window area.

The coated glass uses the CeO₂ film layer or the La₂O₃ film layer. Due to a characteristic that CeO₂ or La₂O₃ is easily dissolved in a weak acid, a weak acid solution may be used to perform deplating on the coated glass. Therefore, the obtained coated glass is less corroded, and has an excellent performance rate.

Optionally, in an implementation of the second aspect, a layer of decorative texture is sandwiched between the CeO₂ film layer or the La₂O₃ film layer and the glass, where the decorative texture is attached to the non-window area.

Optionally, in another implementation of the first aspect and the second aspect, the CeO₂ film layer or the La₂O₃ film layer is 30 nm thick.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic diagram of glass with a window area and a non-window area;

FIG. 2 is a flowchart of a fabrication method of coated glass with a window area according to an embodiment of the present invention;

FIG. 3 is a flowchart of another fabrication method of coated glass with a window area according to an embodiment of the present invention; and

FIG. 4 is a schematic structural diagram of coated glass with a window area according to an embodiment of the present invention.

### DESCRIPTION OF EMBODIMENTS

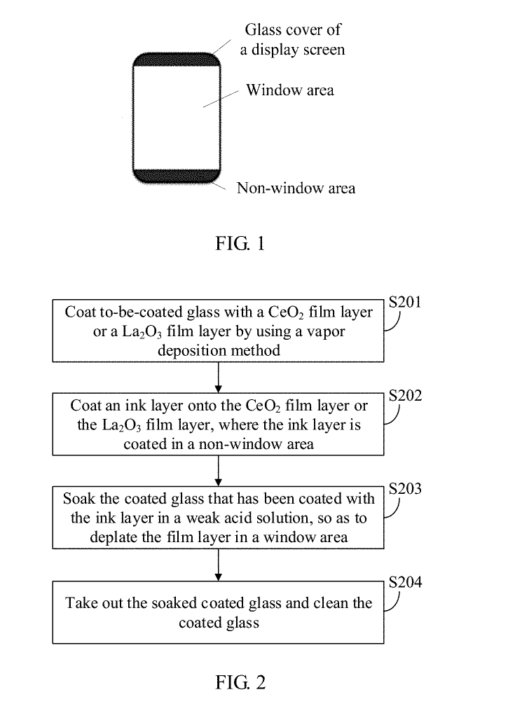

Glass is a common material. Generally, glass of an electronic terminal, such as glass that covers a display, a lens, and the like of the electronic terminal, includes a window area and a non-window area. A window area of a display is an area used to display information, and a window area of a lens is an area used to collect light. Function implementation of the window area relies on an optical characteristic of the glass. Correspondingly, the non-window area is a printing area at the periphery of the window area of the glass. For example, as shown in FIG. 1, on a display screen of a mobile phone, a rectangular display area is a window area, and the remaining non-display area is a non-window area.

To make the glass present a visual effect, such as visual brightness, a reflective color, or a metallic appearance, decorative processing such as coating may be performed on the glass of the electronic terminal. To ensure excellent optical properties, such as a transmittance and a refractive index, of the window area, generally, decorative processing is not performed on the window area. Therefore, after coating is performed on the entire glass, a coated film in the window area needs to be removed, that is, deplating processing needs to be performed on the window area.

Currently, a strong acid or a strong alkali is used to corrode a film layer in a window area, to remove the film layer in the window area. However, the strong acid or the strong alkali is relatively strongly corrosive to glass, and consequently, an invisible tiny scratch on the glass becomes visible.

An objective of a fabrication method of coated glass provided in this application is to reduce corrosion on glass during a deplating process.

FIG. 2 shows a fabrication method of coated glass with a window area, including the following steps.

S201: Coat a base layer with a cerium oxide CeO₂ film layer or a lanthanum oxide La₂O₃ film layer by using a vapor deposition method.

Specifically, in this embodiment, the base layer is to-be-coated glass.

During a research process, the applicant finds that: The CeO₂ or La₂O₃ film layer has a high refractive index, and during optical decorative coating, can produce an effect approximating to that produced by a conventional Ti₃O₅ or TiO₂ film layer. CeO₂ or La₂O₃ has a characteristic of being easily dissolved in a weak acid.

Specifically, in this embodiment, the CeO₂ or La₂O₃ film layer is 30 nm thick.

Specifically, currently, a feasible vapor deposition method includes a chemical vapor deposition method and a physical vapor deposition method. Optionally, in this embodiment, the physical vapor deposition method is used. The physical vapor deposition method refers to a technology in which a material source is gasified into a gaseous atom or molecule or is partially ionized into an ion under a vacuum condition by using a physical method, so as to deposit, on a surface of a substrate, a thin film that has a special function.

S202: Coat an ink layer onto the CeO₂ film layer or the La₂O₃ film layer, where the ink layer is coated in a non-window area.

During a research process, the applicant finds that performance, such as adhesion and environment reliability, of ink on the CeO₂ or La₂O₃ layer also meets a usage requirement. A purpose of coating the ink layer is to achieve an appearance decorating effect and to make a back cover of a mobile phone invisible.

S203: Soak the coated glass that has been coated with the ink layer in a weak acid solution, so as to deplate the CeO₂ film layer or the La₂O₃ film layer in a window area.

Optionally, the weak acid solution used in this embodiment may be a citric acid solution or an acetic acid solution. A higher concentration of the weak acid solution indicates a shorter time required for completing deplating. Specifically, a concentration of the citric acid solution or the acetic acid solution may be 0.01 mol/L to 5 mol/L, and in this embodiment, may preferably be 0.05 mol/L to 1 mol/L.

Optionally, the coated glass that has been coated with the ink layer may be soaked in the weak acid solution for five seconds to five minutes, and in this embodiment, may preferably be soaked for one minute to two minutes.

It should be noted that, in addition to a concentration of the weak acid solution, a temperature is also one of factors affecting a time required for completing deplating. Generally, a higher temperature indicates a shorter time required for completing deplating. Certainly, the foregoing conditions may interact with and affect each other, and details are not described herein.

S204: Take out the soaked coated glass and clean the coated glass.

A purpose of cleaning is to clean off a residual weak acid solution on the coated glass. For a cleaning manner, reference may be made to an existing manner, for example, using clear water for cleaning. In this embodiment, for thorough cleaning, an ultrasonic cleaning manner is preferably used.

In the fabrication method of coated glass with a window area provided in this embodiment, the glass is coated with CeO₂ or La₂O₃, and deplating is performed on the window area by correspondingly using a weak acid due to a characteristic that CeO₂ or La₂O₃ is easily dissolved in a weak acid. The weak acid is less corrosive than a strong acid or a strong alkali, and therefore, corrosion on the glass can be reduced. Therefore, the method provided in this embodiment is applicable to coating acid-resistant glass, and especially applicable to coating acid-nonresistant glass.

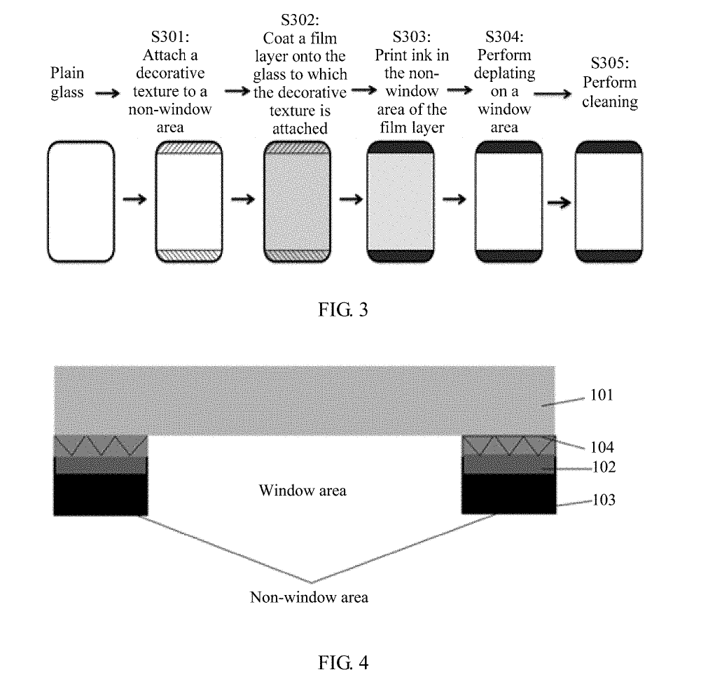

FIG. 3 shows another fabrication method of coated glass with a window area. Compared with the method in FIG. 2, in the method in FIG. 3, a difference lies in that before coating is performed, a decorative texture is attached to glass to increase appearance artistry.

The method in FIG. 3 specifically includes the following steps.

S301: Attach a decorative texture to a non-window area of to-be-coated glass.

Specifically, the decorative texture is a pattern visible to naked eyes, for example, a small ring. The decorative texture may be printed on the to-be-coated glass.

Different from a planar decorative function of ink, the decorative texture can produce a spatial visual effect.

S302: Coat a base layer with a CeO₂ film layer or a La₂O₃ film layer by using a vapor deposition method.

Specifically, in this embodiment, the base layer is the to-be-coated glass and a layer of decorative texture attached to the to-be-coated glass. That is, the CeO₂ film layer or the La₂O₃ film layer is coated on the glass to which the decorative texture is attached.

S303: Coat an ink layer in the non-window area of the CeO₂ film layer or the La₂O₃ film layer.

S304: Soak the coated glass that has been coated with the ink layer in a weak acid solution, so as to deplate the CeO₂ film layer or the La₂O₃ film layer in a window area.

S305: Take out the soaked coated glass and clean the coated glass.

The following example is used: Corning gorilla glass 4 is used as a base material for fabricating coated glass. A 30 nm La₂O₃ film layer is deposited on a surface of the glass by using a physical vapor deposition method, ink is printed on the film layer, and the glass that has been coated with the film layer and the ink is soaked in a 0.05 mol/L to 0.1 mol/L acetic acid solution for one minute to two minutes, and is taken out and cleaned by means of ultrasonic cleaning. In this way, the coated lanthanum oxide film in a window area of the glass is completely deplated. Experiments show that the coated glass obtained by using the foregoing method has a scratch defect rate of 5% and a scratch defect-free rate of 95%, and has a higher scratch defect-free rate compared with that of coated glass obtained by using a conventional coating method (a scratch defect rate is approximately 50%).

FIG. 4 is a schematic structural diagram of coated glass with a window area disclosed in this application. The coated glass includes:

glass 101 with a window area and a non-window area, a CeO₂ film layer or a La₂O₃ film layer 102 disposed on the glass, and an ink layer 103 coated on the CeO₂ film layer or the La₂O₃ film layer.

The CeO₂ film layer or the La₂O₃ film layer is coated in the non-window area other than the window area, and the ink layer is also coated in the non-window area other than the window area. Specifically, the CeO₂ film layer or the La₂O₃ film layer is 30 nm thick.

Optionally, the glass shown in FIG. 4 further includes a layer of decorative texture 104 that is sandwiched between the CeO₂ film layer or the La₂O₃ film layer and the glass. The decorative texture is attached to the non-window area.

The coated glass shown in FIG. 4 may be obtained by using the method in FIG. 2 or FIG. 3.

The film layer of the coated glass provided in this embodiment is dissolved easily in a weak acid. Therefore, a weak acid solution may be used to perform deplating on the window area. In this way, the glass is less corroded, and has a relatively high yield.

The embodiments in this specification are all described in a progressive manner. For same or similar parts in the embodiments, reference may be made to these embodiments. Each embodiment focuses on a difference from other embodiments.

The embodiments disclosed above are described to enable a person skilled in the art to implement or use the present invention. Various modifications made to these embodiments are apparent to a person skilled in the art. Therefore, the present invention is not intended to be limited to these embodiments illustrated in this specification, but shall be construed in the widest scope consistent with the principles and novel features disclosed in this specification.

1. A fabrication method of coated glass with a window area, comprising:
coating a base layer with a cerium oxide CeO₂ film layer or a lanthanum oxide La₂O₃ film layer by using a vapor deposition method, wherein the base layer comprises to-be-coated glass, or to-be-coated glass and another layer coated on the to-be-coated glass;
coating an ink layer onto the CeO₂ film layer or the La₂O₃ film layer, wherein the ink layer is coated in a non-window area; and
soaking the coated glass that has been coated with the ink layer in a weak acid solution, so as to deplate the CeO₂ film layer or the La₂O₃ film layer in a window area.

2. The method according to claim 1, wherein
the weak acid solution is a 0.01 mol/L to 5 mol/L acetic acid solution or a 0.01 mol/L to 5 mol/L citric acid solution.

3. The method according to claim 1, wherein the soaking the coated glass that has been coated with the ink layer in a weak acid solution comprises:
soaking the coated glass that has been coated with the ink layer in the weak acid solution for five seconds to five minutes.

4. The method according to claim 1, wherein after the soaking the coated glass that has been coated with the ink layer in a weak acid solution, the method further comprises:
taking out the soaked coated glass and cleaning the coated glass.

5. The method according to claim 1, wherein before the coating a base layer with a CeO₂ film layer or a La₂O₃ film layer by using a vapor deposition method, the method further comprises:
attaching a decorative texture to the to-be-coated glass, wherein the decorative texture is attached to the non-window area; and
the coating a base layer with a CeO₂ film layer or a La₂O₃ film layer by using a vapor deposition method comprises:
coating the base layer with the CeO₂ film layer or the La₂O₃ film layer by using the vapor deposition method, wherein the base layer comprises the to-be-coated glass and the decorative texture attached to the to-be-coated glass.

6. The method according to claim 1, wherein the deposition method comprises a physical vapor deposition method.

7. The method according to claim 1, wherein the CeO₂ film layer or the La₂O₃ film layer is 30 nm thick.

8. Coated glass with a window area, comprising:
glass with a window area and a non-window area, a CeO₂ film layer or a La₂O₃ film layer disposed on the glass, and an ink layer coated on the CeO₂ film layer or the La₂O₃ film layer, wherein the CeO₂ film layer or the La₂O₃ film layer is coated in the non-window area other than the window area, and the ink layer is coated in the non-window area other than the window area.

9. The coated glass according to claim 8, wherein
a layer of decorative texture is sandwiched between the CeO₂ film layer or the La₂O₃ film layer and the glass, wherein the decorative texture is attached to the non-window area.

10. The coated glass according to claim 8, wherein
the CeO₂ film layer or the La₂O₃ film layer is 30 nm thick.
